(19) United States
(12) Patent Application Publication
(10) Pub. No.: US 2008/0002845 A1
(43) Pub. Date: Jan. 3, 2008

(54) Auditory Head Outside Lateralization Apparatus and Auditory Head Outside Lateralization Method

(76) Inventor: Shunsaku Imaki, Kanagawa (JP)

Correspondence Address: MCDERMOTT WILL & EMERY LLP, 600 13TH STREET, NW, WASHINGTON, DC, 20005-3096, US

(21) Appl. No.: 11/665,818

(22) PCT Filed: Aug. 16, 2005
(86) PCT No.: PCT/JP05/14949

§ 371 Date: Apr. 19, 2007

(30) Foreign Application Priority Data
Feb. 17, 2005 (JP) 2005-040325

(51) Int. Cl. H04S 1/00; H04R 5/00

(52) U.S. Cl. 381/310

(57) ABSTRACT

The capacity of storage means required for generating virtual reflected sounds of left and right channels is saved. An auditory head outside lateralization apparatus has auditory lateralization means 102, 103 for processing input audio signals of left and right channels to localize a sound field at any desired position assumed with the head of a person wearing a headphone as the reference, and calculating the audio signals generated from a virtual sound field, virtual reflected sound generation means 111 for calculating virtual reflected sounds in a virtual sound field space relative to left and right channels from the one-channel audio signal resulting from adding the input audio signals of left and right channels, and addition means 112 or adding the audio signals of the left and right channels output from the auditory lateralization means and the virtual reflected sound generation means and calculating the audio signal from any desired virtual sound field.

### TECHNICAL FIELD

This invention relates to an auditory head outside lateralization apparatus and an auditory head outside lateralization method for localizing the sound image of an audio signal at any desired position of the head outside of a user when the user listens to the audio signal through a headphone.

### BACKGROUND ART

Hitherto, a method of forming a virtual loudspeaker sound and a virtual reflected sound generated from a virtual sound field based on an audio signal input for each of left and right channels has been proposed as a technique of localizing the sound image of an audio signal at any desired position of the head outside of the user when the user listens to the audio signal through a headphone (for example, refer to patent document 1).

FIG. 3 is a diagram to show the internal configuration of an auditory head outside lateralization apparatus for implementing the auditory head outside lateralization method in the related art. Audio signals of left and right channels played back by an appropriate audio machine are input as input signals (IL and IR in the figure) and each of the input signals of the left and right channels is branched into at least two systems. Left and right loudspeaker sounds assumed in an appropriate sound field space assumed with the head of the person wearing the headphone as the reference and virtual reflected sounds in a virtual sound field space of the sounds produced from the left and right virtual loudspeakers are formed from the signals of the systems of the left and right channels.

That is, the left and right virtual loudspeaker sounds are processed by a direct sound signal control section (D_{SC} in the figure) so as to become direct sound signals to form virtual loudspeaker sound signals, and the virtual reflected sounds are processed by a reflected sound signal control section (E_{SC} in the figure) so as to become reflected sound signals to form virtual reflected sound signals. The direct sound signals and the reflected sound signals of the left and right channels thus formed are mixed by a left channel mixer and a right channel mixer (M_{L} and M_{R} in the figure) and the outputs of the left and right mixers are input to left and right ear loudspeakers of the headphone.

Patent document 1: JP-A-2000-115899 (p3-p6, FIG. 2)

### DISCLOSURE OF THE INVENTION

### PROBLEMS TO BE SOLVED BY THE INVENTION

Since the auditory head outside lateralization apparatus in the related art forms the virtual reflected sound for each of the left and right channels, two storage means of the audio signals used to form the virtual reflected sounds are required and further it is necessary to increase the capacity of the storage means to prolong the duration of the virtual reflected sound depending on the virtual space and thus the circuit scale and the computation amount grow and the power consumption also increases; this is a problem.

It is an object of the invention to provide an auditory head outside lateralization apparatus and an auditory head outside lateralization method for making it possible to save the capacity of storage means required for generating virtual reflected sounds of left and right channels.

### MEANS FOR SOLVING THE PROBLEMS

An auditory head outside lateralization apparatus of the invention has auditory lateralization means for processing input audio signals of left and right channels to localize a sound field at any desired position assumed with the head of a person wearing a headphone as the reference, and calculating the audio signals generated from a virtual sound field; virtual reflected sound generation means for calculating virtual reflected sounds in a virtual sound field space relative to left and right channels from the one-channel audio signal resulting from adding the input audio signals of left and right channels; and addition means for adding the audio signals of the left and right channels output from the auditory lateralization means and the virtual reflected sound generation means and calculating the audio signal from any desired virtual sound field. According to the described configuration, the audio signal to form a virtual reflected sound is monaural and thus one storage means for storing the audio signal may be provided and the circuit scale can be reduced.

In the invention, the virtual reflected sound generation means performs computation processing using a virtual reflected sound coefficient of the left channel and that of the right channel extracting a feature element from the reflection characteristic of any desired virtual sound field space and calculates the virtual reflected sounds. According to the described configuration, operations incorporating the virtual reflected sound coefficients are performed on the monaural audio signal stored in the same storage means separately for the left and right channels, so that it is not necessary to provide two storage means and the circuit scale can be reduced.

In the invention, the virtual reflected sound generation means includes storage means for storing the one-channel audio signal and feedback loop means for adding an audio signal resulting from multiplying the final audio signal of the stored audio signal by a predetermined feedback gain value to the one-channel audio signal and feeding back the result into the storage means. According to the described configuration, the retention time of the audio signal can be prolonged exceeding the number of the states of the storage means.

### ADVANTAGES OF THE INVENTION

According to the invention, the operations incorporating the virtual reflected sound coefficients are performed on the monaural audio signal in one storage means at the same time to form left and right virtual reflected sounds, so that it is not necessary to provide two storage means and the circuit scale can be reduced.

According to the invention, the feedback loop means enables the retention time of the audio signal to be prolonged exceeding the number of the states of the storage means, and even the small-scaled circuit configuration makes it. possible to prolong the duration of the virtual reflected sound.

### BRIEF DESCRIPTION OF THE DRAWINGS

FIG. 1 is a diagram to show the internal configuration of an auditory head outside lateralization apparatus in an embodiment of the invention.

FIG. 2 is a diagram to show the detailed configuration of virtual reflected sound generation means of the auditory head outside lateralization apparatus in the embodiment of the invention.

FIG. 3 is a diagram to show the internal configuration of an auditory head outside lateralization apparatus for implementing an auditory head outside lateralization method in a related art.

### DESCRIPTION OF REFERENCE NUMERALS

100 Rch audio input signal

101 Lch audio input signal

102 Rch auditory lateralization means

103 Lch auditory lateralization means

104 Rch main output signal

105 Rch cross output signal

106 Lch cross output signal

107 Lch main output signal

108 Rch virtual reflected sound output signal

109 Lch virtual reflected sound output signal

110 Rch and Lch input adder

111 Virtual reflected sound generation means

112 Direct sound and virtual reflected sound addition means

113 Rch direct sound and virtual reflected sound adder

114 Lch direct sound and virtual reflected sound adder

115 Rch audio output signal

116 Lch audio output signal

200 One-channel audio input signal

201 Virtual reflected sound generation means

202 Feedback loop means

203 Storage means

204 Rch virtual reflected sound computation means

205 Lch virtual reflected sound computation means

206 Feedback gain multiplier

207 Feedback adder

208 Rch virtual reflected sound output signal

209 Lch virtual reflected sound output signal

### BEST MODE FOR CARRYING OUT THE INVENTION

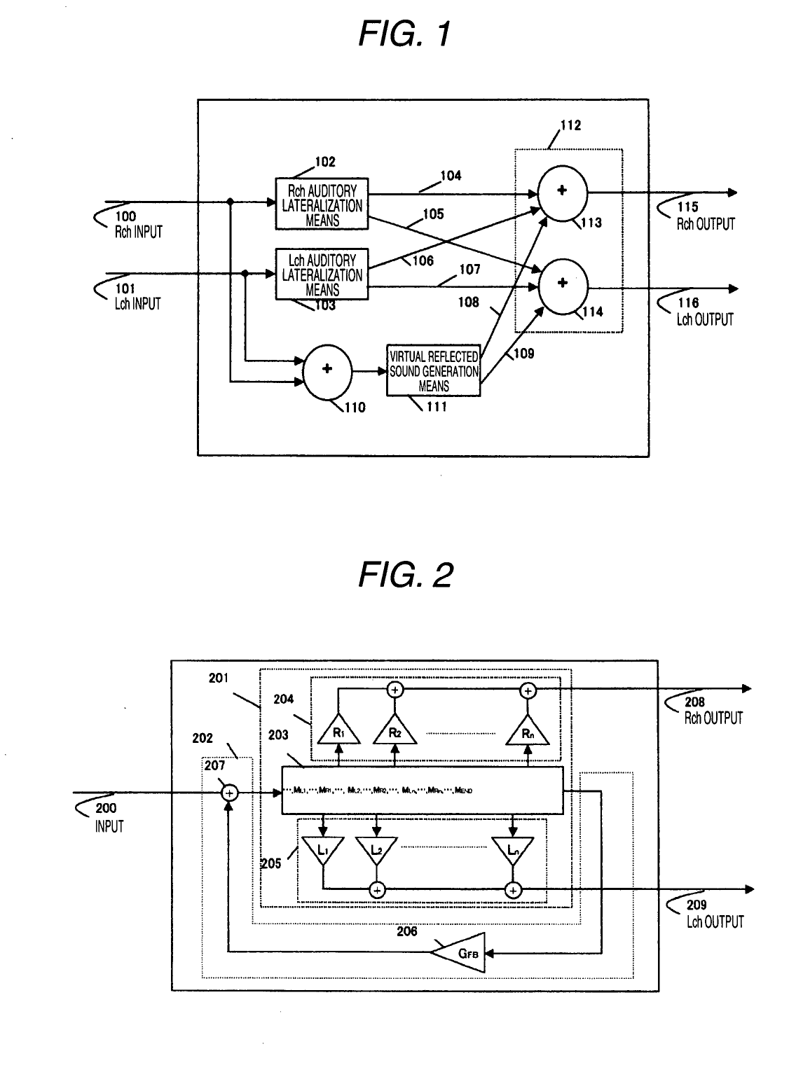

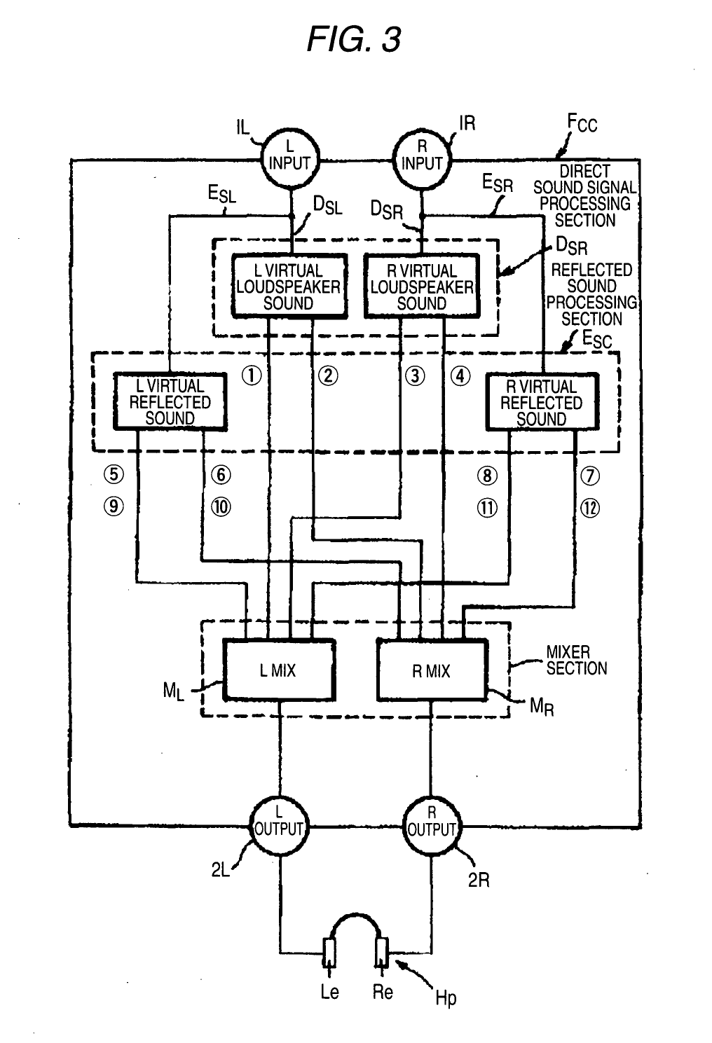

An auditory head outside lateralization apparatus according to an embodiment of the invention will be discussed with reference to the accompanying drawings. FIG. 1 is a diagram to show the internal configuration of the auditory head outside lateralization apparatus in the embodiment of the invention.

The auditory head outside lateralization apparatus is mainly made up of auditory lateralization means 102 and 103 for left and right channels, virtual reflected sound generation means 111, direct sound and virtual reflected sound addition means 112, etc.

The auditory lateralization means is made up of Rch auditory lateralization means 102 for the right channel (which will be hereinafter referred to as Rch) and Lch auditory lateralization means 103 for the left channel (which will be hereinafter referred to as Lch) and inputs audio signals of two channels output from an audio machine (Rch audio input signal 100 and Lch audio input signal 101) and processes the Rch audio input signal 100 and the Lch audio input signal 101 to localize a sound field at any desired position assumed with the head of the person wearing the headphone as the reference, thereby calculating the audio signals generated from a virtual sound field. The auditory lateralization processing may be performed using a known technique and therefore will not be discussed here in detail.

The virtual reflected sound generation means 111 calculates a virtual reflected sound in the virtual sound field from the audio signal of one channel generated by adding the Rch audio input signal 100 and the Lch audio input signal 101 by an Rch and Lch input adder 110 provided preceding the virtual reflected sound generation means 111. The detailed configuration of the virtual reflected sound generation means 111 is described later.

The direct sound and virtual reflected sound addition means 112 is made up of an Rch direct sound and virtual reflected sound adder 113 and an Lch direct sound and virtual reflected sound adder 114 and adds audio signals output from the Rch auditory lateralization means 102 and the Lch auditory lateralization means 103 (Rch main output signal 104, Rch cross output signal 105, Lch cross output signal 106, and Lch main output signal 107) and audio signals output from the virtual reflected sound generation means 111 (Rch virtual reflected sound output signal 108 and Lch virtual reflected sound output signal 109). The direct sound and virtual reflected sound addition means 112 can output audio signals generated from any desired virtual sound field in the virtual space (Rch audio output signal 115 and Lch audio output signal 116).

FIG. 2 is a diagram to show the detailed configuration of the virtual reflected sound generation means 111 of the auditory head outside lateralization apparatus in the embodiment of the invention. The virtual reflected sound generation means 111 is mainly made up of virtual reflected sound generation means 201, feedback loop means 202, storage means 203, etc.

The virtual reflected sound generation means 201 is made up of computation means (Rch virtual reflected sound computation means 204 and Lch virtual reflected sound computation means 205) for calculating the virtual reflected sound of each channel by multiplying the value at any desired stage number (MR1, MR2, . . . , MRn, ML1, ML2, . . . , MLn) from the storage means 203 by a predetermined gain value (R1, R2, . . . , Rn, L1, L2, . . . , Ln) and adding the multiplication results.

The feedback loop means 202 is made up of a feedback gain multiplier 206 for multiplying the value at the last stage (MEND) of the storage means 203 by a feedback gain value (GFB) and a feedback adder 207 for adding the output of the feedback gain multiplier to a one-channel audio input signal 200 on the input side and outputting the result to the storage means 203.

The storage means 203 temporarily stores the input one-channel audio input signal 200.

Next, the operation of the virtual reflected sound generation means of the configuration described above is as follows: In the auditory head outside lateralization apparatus in the embodiment of the invention, combination of the stage number (MR1, MR2, . . . , MRn, ML1, ML2, . . . , MLn) input from the storage means 203 and the gain value (R1, R2, Rn, L1, L2, . . . , Ln) by which the value at the stage number is multiplied is defined as virtual reflected sound coefficient in the computation means (Rch virtual reflected sound computation means 204 and Lch virtual reflected sound computation means 205), and the virtual reflected sound coefficient is applied to Rch and Lch.

Therefore, as shown in FIG. 2, the Rch virtual reflected sound computation means 204 performs right channel operations on the one-channel audio input signal 200 output from the Rch and Lch input adder 110 and input to the storage means 203, and outputs an Rch virtual reflected sound output signal 208 as a virtual reflected sound signal for the right channel. Likewise, the Lch virtual reflected sound computation means 205 performs left channel operations on the one-channel audio input signal 200 and outputs an Lch virtual reflected sound output signal 209 as a virtual reflected sound signal for the left channel. Thus, both left and right virtual reflected sounds can be generated and output even from a one-channel audio signal.

On the other hand, the feedback loop means 202 multiplies the value at the last stage (MEND) of the one-channel audio input signal 200 output from the Rch and Lch input adder 110 and input to the storage means 203 by the feedback gain value (GFB) by the feedback gain multiplier 206 and again inputs the multiplication result into the storage means 203. Thus, it is made possible to retain the audio signals exceeding the number of the stages of the storage means 203, and the duration of the virtual reflected sound can be prolonged exceeding the capacity of the storage means.

Next, the operation of the auditory head outside lateralization apparatus described above is as follows: To begin with, the Rch auditory lateralization means 102 performs auditory lateralization processing for the Rch audio input signal 100 of the audio signals of two channels output from an audio machine and outputs the Rch main output signal 104 as the right channel signal of the direct sound generated from the virtual sound field. It also outputs the Rch cross output signal 105.

Likewise, the Lch auditory lateralization means 103 performs auditory lateralization processing for the Lch audio input signal 101 and outputs the Lch main output signal 107 as the left channel signal of the direct sound generated from the virtual sound field. It also outputs the Lch cross output signal 106.

On the other hand, the virtual reflected sound generation means 111 performs the above-described virtual reflected sound generation processing for the one-channel audio signal resulting from performing addition processing of the audio signals of two channels output from the audio machine by the Rch and Lch input adder 110 and outputs the Rch virtual reflected sound output signal 108 as the virtual reflected sound for the right channel and the Lch virtual reflected sound output signal 109 as the virtual reflected sound for the left channel.

Next, the Rch direct sound and virtual reflected sound adder 113 of the direct sound and virtual reflected sound addition means 112 adds the Rch main output signal 104 output from the Rch auditory lateralization means 102, the Lch cross output signal 106 output from the Lch auditory lateralization means 103, and the Rch virtual reflected sound output signal 108 output from the virtual reflected sound generation means 111, and outputs the result as the Rch audio output signal 115.

Likewise, the Lch direct sound and virtual reflected sound adder 114 adds the Rch cross output signal 105 output from the Rch auditory lateralization means 102, the Lch main output signal 107 output from the Lch auditory lateralization means 103, and the Lch virtual reflected sound output signal 109 output from the virtual reflected sound generation means 111, and outputs the result as the Lch audio output signal 116.

As described above, the auditory head outside lateralization apparatus in the embodiment of the invention can use one storage means to generate and output both left and right virtual reflected sounds from the one-channel audio signal. In the auditory head outside lateralization apparatus in the embodiment of the invention, it is made possible to retain the audio signals exceeding the number of the stages of the storage means, and even the small-scaled circuit configuration makes it possible to prolong the duration of the virtual reflected sound.

### INDUSTRIAL APPLICABILITY

The auditory head outside lateralization apparatus and the auditory head outside lateralization method of the invention have the advantages that the capacity of the storage means required for calculating the virtual reflected sound can be saved and that the duration of the virtual reflected sound can be prolonged exceeding the capacity of the storage means; they are useful for a portable audio machine, a stereo machine of a gaming machine, etc.

1. An auditory head outside lateralization apparatus comprising:
an auditory lateralization means for processing input audio signals of left and right channels to localize a sound field at any desired position assumed with the head of a person wearing a headphone as the reference, and calculating the audio signals generated from a virtual sound field;
virtual reflected sound generation means for calculating virtual reflected sounds in a virtual sound field space relative to left and right channels from the one-channel audio signal resulting from adding the input audio signals of left and right channels; and
addition means for adding the audio signals of the left and right channels output from said auditory lateralization means and said virtual reflected sound generation means and calculating the audio signal from any desired virtual sound field.

2. The auditory head outside lateralization apparatus as claimed in claim 1, wherein said virtual reflected sound generation means performs computation processing using a virtual reflected sound coefficient of the left channel and that of the right channel extracting a feature element from the reflection characteristic of any desired virtual sound field space and calculates the virtual reflected sounds.

3. The auditory head outside lateralization apparatus as claimed in claim 1, wherein said virtual reflected sound generation means comprises storage means for storing the one-channel audio signal and feedback loop means for adding an audio signal resulting from multiplying the final audio signal of the stored audio signal by a predetermined feedback gain value to the one-channel audio signal and feeding back the result into the storage means.

4. An auditory head outside lateralization method comprising:
an auditory lateralization step of processing input audio signals of left and right channels to localize a sound field at any desired position assumed with the head of a person wearing a headphone as the reference, and calculating the audio signals generated from a virtual sound field;
a virtual reflected sound generation step of calculating virtual reflected sounds in a virtual sound field space relative to left and right channels from the one-channel audio signal resulting from adding the input audio signals of left and right channels; and
an addition step of adding the audio signals of the left and right channels output in said auditory lateralization step and said virtual reflected sound generation step and calculating the audio signal from any desired virtual sound field.
